(19) United States
(12) Patent Application Publication
(10) Pub. No.: US 2026/0008416 A1
(43) Pub. Date: Jan. 8, 2026

(54) EXTENDABLE LOAD BEARING FLOOR FOR VEHICLES

(71) Applicant: Multimatic Inc., Markham (CA)

(72) Inventors: Tyler James BEVAN, Markham (CA); Muamer HODZA, Markham (CA)

(21) Appl. No.: 19/123,552

(22) PCT Filed: Oct. 25, 2022
(86) PCT No.: PCT/CA2022/051576

§ 371 Date: Apr. 23, 2025

(51) Int. Cl. B60R 5/04

(52) U.S. Cl. CPC B60R 5/041

(57) ABSTRACT

An integrated and extendable load bearing floor of a vehicle includes a frame, a sliding mechanism slidingly coupled with the frame in a longitudinal direction, a first floor connected to the sliding mechanism, and a release handle adapted to trigger a locking mechanism. The locking mechanism locks the sliding mechanism and the first floor connected thereto in two or more different positions and is triggered to unlock the sliding mechanism and the first floor connected thereto from any position to freely translate longitudinally in relation to the frame.

### FIELD OF THE DISCLOSURE

This disclosure relates to cargo areas of vehicles, and more particularly to an extendable load bearing floor for vehicles that facilitates loading and unloading of cargo and provides additional cargo space to the vehicle when stationary.

### BACKGROUND

In general, automotive vehicles include a cargo area with a fixed amount of cargo space in a rear portion of the vehicle. In certain instances, there may be a desire to have greater cargo space and utility as it pertains to the cargo area of vehicles. For example, loading and unloading cargo to and from a cargo area of a Sports Utility Vehicle (SUV) may be challenging due to a proximity of the cargo area walls in relation to the cargo, an unloading location of the cargo, a depth of the cargo area, or a body of the SUV limiting side access to the cargo area. In some cases, utility of the cargo area as a working surface is also limited due to the body of the SUV on either side of the cargo area. Accordingly, it would be advantageous to create an extendable load bearing floor for vehicles that facilitates loading and unloading of cargo and provides additional cargo space to the vehicle when stationary.

### SUMMARY

An aspect of the invention includes an extendable load bearing floor for a vehicle, comprising: a frame; a sliding mechanism slidingly coupled with the frame in a longitudinal direction; a first floor connected to the sliding mechanism; and a release handle adapted to trigger a locking mechanism; wherein: the locking mechanism locks the sliding mechanism and the first floor connected thereto in at least a stowed position and an extended position; the locking mechanism is triggered to unlock the sliding mechanism and the first floor connected thereto from either of the stowed position and the extended position to freely translate longitudinally in relation to the frame between the stowed position and the extended position and vice versa; and the extendable load bearing floor is integrated into the vehicle.

In further aspects of the invention, the extendable load bearing floor further comprises a second floor positioned above the first floor such that the first floor is stowed beneath the second floor when in the stowed position and slides out from beneath the second floor when transitioning from the stowed position to the extended position. In further aspects of the invention, the second floor is a floor of a bed of the vehicle.

In further aspects of the invention, the sliding mechanism comprises: a pair of rails slidingly coupled with opposite sides of the frame in the longitudinal direction; wherein: the outer surface of each rail faces the inner surface of the respective side of the frame to which each rail is slidingly coupled in the longitudinal direction; the first floor is connected to each rail and positioned in between an inner surface of each rail; and guide rollers and load rollers facilitate longitudinal translation of each rail in relation to the frame, wherein: one guide roller is mounted to at least each of an inner surface of a front portion of each side of the frame and an outer surface of a rear portion of each rail; and one load roller is mounted to at least each of the inner surface of the front portion of each side of the frame and the outer surface of the rear portion of each rail. In further aspects of the invention, a bumper is mounted to at least each of the inner surface of a rear portion and the front portion of each side of the frame; and the bumpers mounted on the rear portion and the front portion of the frame are adapted to engage with the load roller mounted on the outer surface of each rail on a same side as the respective bumper to provide over travel and noise protection in the stowed position and the extended position, respectively.

In further aspects of the invention, the locking mechanism comprises: one striker pin mounted to at least each of a rear portion and a front portion of an inner surface of each side of the frame; one catch mounted to at least each of a rear portion of an outer surface of each side of the sliding mechanism; and one torsion spring connected to each catch; wherein: each catch is connected to the release handle via a cable; in transitioning the first floor from an unlocked state to a locked state, each of the catches rotate upon contact with the striker pin mounted on the rear portion or the front portion of the frame on a same side as the respective catch until fully engaging with the striker pin to lock the first floor in the stowed position or the extended position, respectively; in transitioning the first floor from the locked state to the unlocked state, the release handle triggers the locking mechanism via the connected cables to actuate rotation of each catch from the striker pin to which each respective catch is engaged until fully disengaging from the striker pin to unlock the first floor from the stowed position or the extended position; and each torsion spring returns the respective catch to which it is connected to an unrotated position, after a force causing rotation of the respective catch during locking or unlocking of the first floor is released. In further aspects of the invention, the locking mechanism further comprises one catch bumper mounted to at least each of the rear portion of the outer surface of each side of the sliding mechanism to limit an amount of rotation of the catch mounted on a same side. In further aspects of the invention, the sliding mechanism comprises: a pair of rails slidingly coupled with opposite sides of the frame in the longitudinal direction; wherein: the outer surface of each rail faces the inner surface of the respective side of the frame to which each rail is slidingly coupled in the longitudinal direction; the first floor is connected to each rail and positioned in between an inner surface of each rail; guide rollers and load rollers facilitate longitudinal translation of each rail in relation to the frame, wherein: one guide roller is mounted to at least each of an inner surface of a front portion of each side of the frame and an outer surface of a rear portion of each rail; and one load roller is mounted to at least each of the inner surface of the front portion of each side of the frame and the outer surface of the rear portion of each rail; and the rear portion of the outer surface of each side of the sliding mechanism comprises the outer surface of the rear portion of each rail.

In further aspects of the invention, the extendable load bearing floor further comprises at least two hooks mounted to the frame on opposite sides. In further aspects of the invention, each of the at least two hooks comprises a tie down eye adapted to pivot up to 90 degrees and stow flush for storage.

In further aspects of the invention, the release handle is mounted to an underside of the first floor.

In further aspects of the invention, the extendable load bearing floor further comprises at least two vertically limiting stops mounted to opposite sides of one of the frame and the sliding mechanism to prevent the first floor from moving in a vertical direction in relation to the frame. In further aspects of the invention, the at least two vertically limiting stops are fabricated using injection molding.

In further aspects of the invention, the locking mechanism locks the sliding mechanism and the first floor connected thereto in at least one additional position between the stowed position and the extended position.

Further aspects of the invention will be apparent from the following description.

### BRIEF DESCRIPTION OF DRAWINGS

FIGS. 1A and 1B illustrate an extendable load bearing floor, according to some embodiments.

FIGS. 2A and 2B illustrate a sliding mechanism of the extendable load bearing floor, according to some embodiments.

FIGS. 3A and 3B illustrate a bumper mounted to a frame of the extendable load bearing floor, according to some embodiments.

FIG. 4 illustrates a locking mechanism of the extendable load bearing floor, according to some embodiments.

FIG. 5 illustrates the extendable load bearing floor in an extended positioned.

FIGS. 6A-6C illustrate the extendable load bearing floor in various positions.

FIGS. 7A and 7B illustrate the extendable load bearing floor integrated into a vehicle, according to some embodiments.

FIG. 8A illustrates the extendable load bearing floor with hooks mounted to the frame of the extendable load bearing floor, according to some embodiments.

FIG. 8B illustrates the hooks, according to some embodiments.

FIG. 9 illustrates the extendable load bearing floor with vertically limiting stops mounted to the frame of the extendable load bearing floor, according to some embodiments.

### DETAILED DESCRIPTION

An aspect of the invention includes an extendable load bearing floor for a vehicle. The extendable load bearing floor includes a frame and a sliding mechanism slidingly coupled with the frame in a longitudinal direction. The extendable load bearing floor further includes a first floor connected to the sliding mechanism, a locking mechanism, and a release handle adapted to trigger the locking mechanism. The locking mechanism locks the sliding mechanism and the first floor connected thereto in at a stowed position and an extended position. In some embodiments, the locking mechanism further locks the sliding mechanism and the first floor connected thereto in one or more additional positions between the stowed position and the extended position. The locking mechanism is triggered to unlock the sliding mechanism and the first floor connected thereto from either of the stowed position and the extended position to freely translate longitudinally in relation to the frame between the stowed position and the extended position and vice versa. In some embodiments, the locking mechanism is triggered to unlock the sliding mechanism and the first floor connected thereto from one or more additional positions between the stowed position and the extended position.

In embodiments, the extendable load bearing floor is integrated into the vehicle. In some embodiments, a second floor is positioned above the first floor such that the first floor is stowed beneath the second floor when in the stowed position and slides out from beneath the second floor when transitioning from the stowed position to the extended position. When a second floor is used, preferably the first floor will be essentially unseen to a user when in the stowed position. The second floor may be the floor of a cargo area of a vehicle, such as a floor of a cargo area of an SUV. To extend the first floor from the stowed position, the release handle is engaged to trigger the locking mechanism, unlocking the locking mechanism such that the sliding mechanism and first floor connected thereto may slide away from the vehicle in a longitudinal direction in relation to the frame until the locking mechanism is engaged, locking the sliding mechanism and first floor connected thereto in the extended position. Extension of the first floor may be used to facilitate loading and unloading of cargo into a cargo area of the vehicle. Additionally, the first floor increases an amount of cargo space of the cargo area of the vehicle when the vehicle is stationary and the first floor is extended. To stow the first floor from the extended position, the release handle is engaged to trigger the locking mechanism, unlocking the locking mechanism such that the sliding mechanism and first floor connected thereto may slide towards the vehicle in the longitudinal direction in relation to the frame until the locking mechanism is engaged, locking the sliding mechanism and first floor connected thereto in the stowed position. In some embodiments, the extendable load bearing floor comprising solely the first floor or the first floor and the second floor is an independent apparatus separate from the vehicle and is attachable to the vehicle.

In some embodiments, the sliding mechanism includes a pair of rails slidingly coupled with opposite sides of the frame in the longitudinal direction such that the outer surface of each rail faces the inner surface of the respective side of the frame to which each rail is slidingly coupled in the longitudinal direction. The first floor is connected to each rail and positioned in between an inner surface of each rail. Guide rollers and load rollers facilitate longitudinal translation of each rail in relation to the frame. In some embodiments, one guide roller is mounted to each of an inner surface of a front portion of each side of the frame and an outer surface of a rear portion of each rail. In some embodiments, one load roller is mounted to each of the inner surface of the front portion of each side of the frame and the outer surface of the rear portion of each rail. The number and arrangement of guide rollers and/or load rollers may vary in embodiments. In some embodiments, one bumper is mounted to each of the inner surface of a rear portion and the front portion of each side of the frame. The number and arrangements of bumpers may vary in embodiments. The bumpers mounted on the rear portion and the front portion of the frame are adapted to engage with the load roller mounted on the outer surface of each rail on a same side as the respective bumper to provide over travel and noise protection in the stowed position and the extended position, respectively. Other sliding mechanisms may be used to achieve a same desired function of the extendable load bearing floor.

In some embodiments, the locking mechanism includes one striker pin mounted to each of a rear portion and a front portion of an inner surface of each side of the frame, one catch mounted to each of a rear portion of an outer surface of each rail of the sliding mechanism, and one torsion spring connected to each catch. The number and arrangement of striker pins and catches may vary in embodiments. Each catch is connected to the release handle via a cable or another means. In transitioning the first floor from an unlocked state to a locked state, each of the catches rotates upon contact with the striker pin mounted on the rear portion or the front portion of the frame on a same side as the respective catch until fully engaging with the striker pin to lock the first floor in the stowed position or the extended position, respectively. In transitioning the first floor from the locked state to the unlocked state, the release handle triggers the locking mechanism via the connected cables to actuate rotation of each catch from the striker pin to which each respective catch is engaged until fully disengaging from the striker pin to unlock the first floor from the stowed position or the extended position. Each torsion spring returns the respective catch to which it is connected to an unrotated position after a force causing rotation of the respective catch during locking or unlocking of the first floor is released. In some embodiments, the locking mechanism includes one catch bumper mounted to each of the rear portion of the outer surface of each rail of the sliding mechanism to limit an amount of rotation of the catch mounted on a same side. The number and arrangement of catch bumpers may vary in embodiments depending on the number and arrangement of catches. In some embodiments, the release handle is mounted to an underside of the first floor.

In some embodiments, the extendable load bearing floor includes two hooks mounted to the frame on opposite sides to facilitate tie downs for cargo stability during movement of the vehicle. The number and arrangement of hooks may vary in embodiments. In some embodiments, each hook includes a tie down eye adapted to pivot up to 90 degrees and stow flush for storage. Other means to facilitate tie downs for cargo may also be used.

In some embodiments, the extendable load bearing floor includes two vertically limiting stops mounted to opposite sides of one of the frame and the sliding mechanism to prevent the first floor from moving in a vertical direction in relation to the frame. The number and arrangement of vertically limiting stops may vary in embodiments. Other mechanisms for preventing vertical movement of the first floor in relation to the frame may be used. In some embodiments, the vertically limiting stops are fabricated using injection molding.

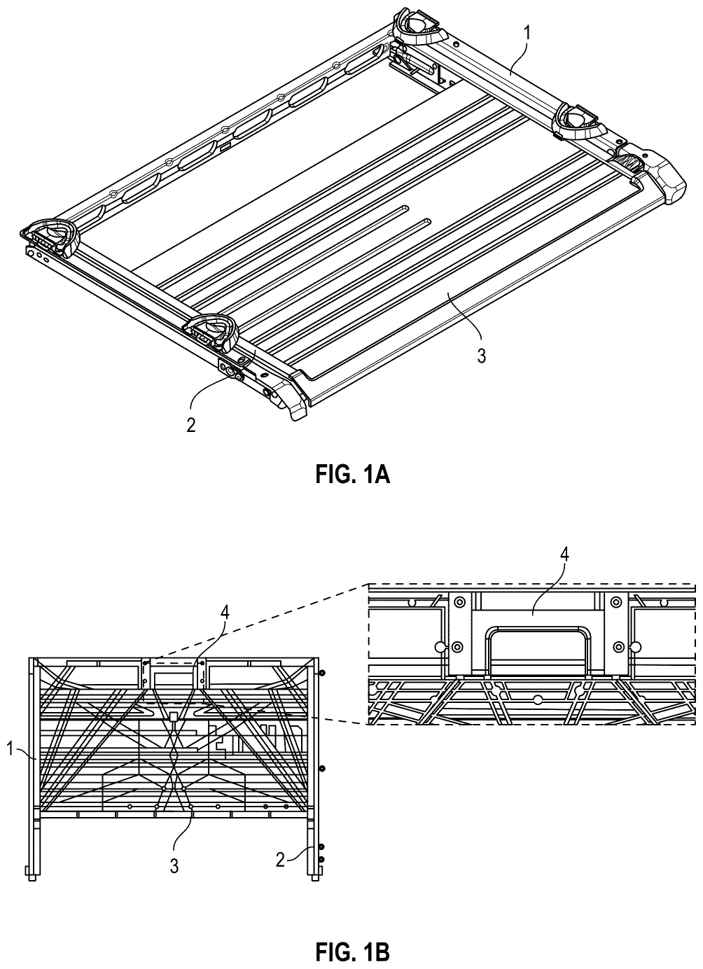

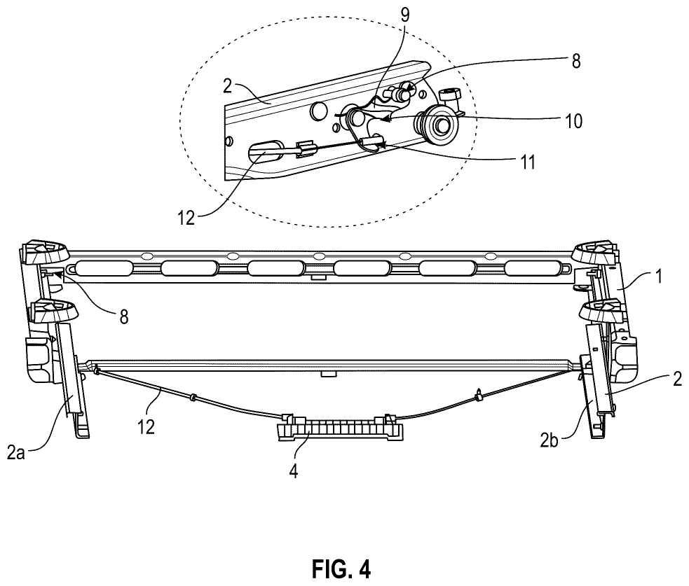

FIGS. 1A and 1B illustrate an embodiment of an extendable load bearing floor including a frame (1), a sliding mechanism (2) slidingly coupled with the frame (1) in a longitudinal direction, a first floor (3) connected to the sliding mechanism (2), and a release handle (4) mounted to an underside of the frame (1) and adapted to trigger a locking mechanism (see FIG. 4).

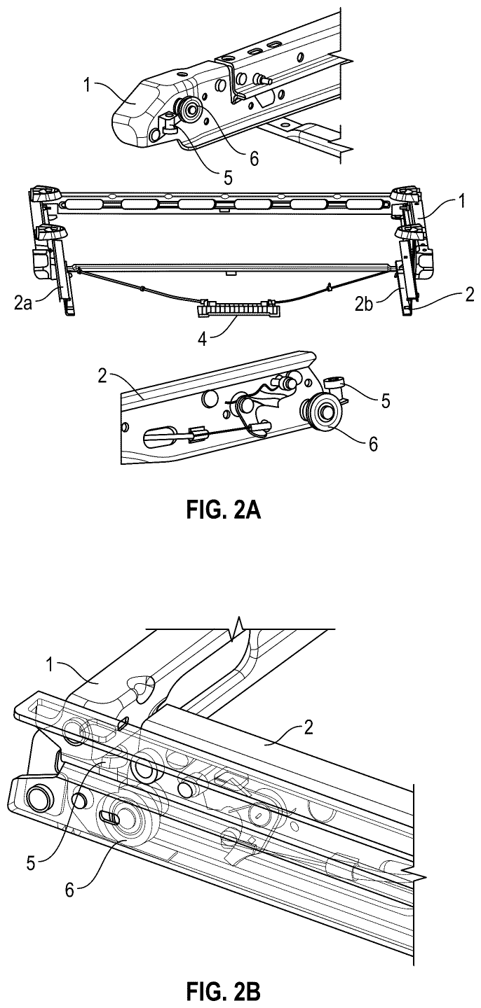

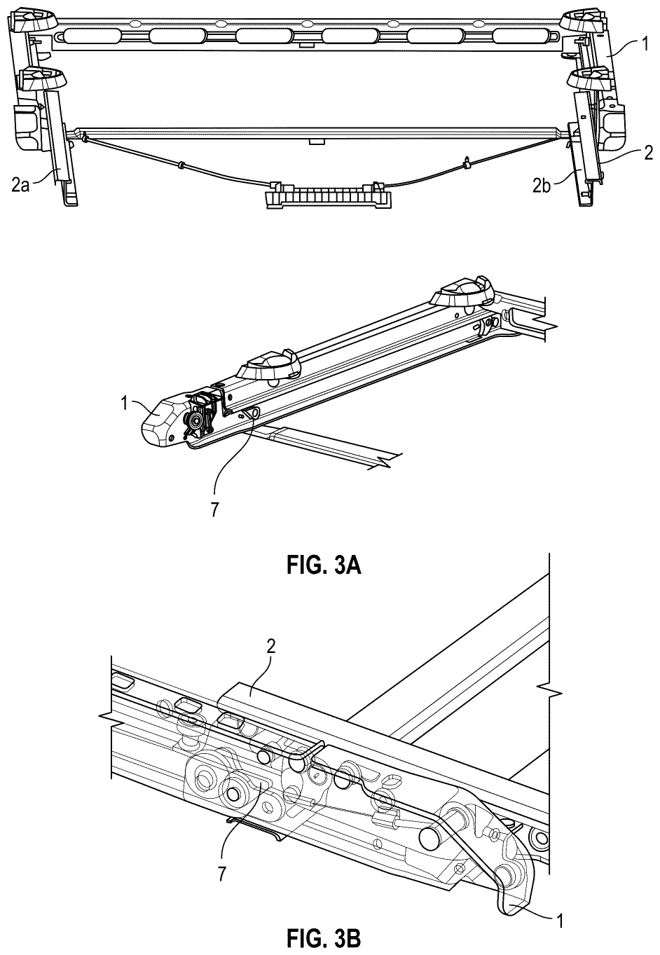

FIGS. 2A and 2B illustrate the sliding mechanism (2) comprised of a pair of rails (2a) and (2b) slidingly coupled with opposite sides of the frame (1) in the longitudinal direction. Though not shown in FIGS. 2A and 2B, the first floor (3) is connected to rails (2a) and (2b) of the sliding mechanism (2) (see FIGS. 1A and 1B). A guide roller (5) is mounted to each of an inner surface of a front portion of each side of the frame (1) and an outer surface of a rear portion of rails (2a) and (2b) of the sliding mechanism (2). A load roller (6) is mounted to each of the inner surface of the front portion of each side of the frame (1) and the outer surface of the rear portion of rails (2a) and (2b) of the sliding mechanism (2). Guide rollers (5) and load rollers (6) facilitate longitudinal translation of rails (2a) and (2b) of the sliding mechanism (2) in relation to the frame (1). FIGS. 3A and 3B illustrate a bumper (7) mounted to each of the inner surface of a rear portion and the front portion of each side of the frame (1). The bumpers (7) mounted on the rear portion and the front portion of the frame (1) are adapted to engage with the load rollers (6) mounted on the outer surface of rails (2a) and (2b) of the sliding mechanism (2) on a same side as the respective bumper (7) to provide over travel and noise protection in the stowed position and the extended position, respectively.

FIG. 4 illustrates the locking mechanism comprised of a striker pin (8) mounted to each of a rear portion and a front portion of an inner surface of each side of the frame (1), a catch (9) mounted to each of a rear portion of an outer surface of rails (2a) and (2b) of the sliding mechanism (2), a torsion spring (10) connected to each catch (9), and a catch bumper (11) mounted to each of the rear portion of the outer surface of rails (2a) and (2b) of the sliding mechanism (2) to limit an amount of rotation of the catch (9) mounted on a same side. Each catch (9) is connected to the release handle (4) via a cable (12). The locking mechanism locks the rails (2a) and (2b) of the sliding mechanism (2) and the first floor (3) connected thereto in a stowed position and an extended position. The locking mechanism is triggered by the release handle (4) to unlock the rails (2a) and (2b) of the sliding mechanism (2) and the first floor (3) connected thereto from either of the stowed position and the extended position to freely translate longitudinally in relation to the frame (1) between the stowed position and the extended position and vice versa.

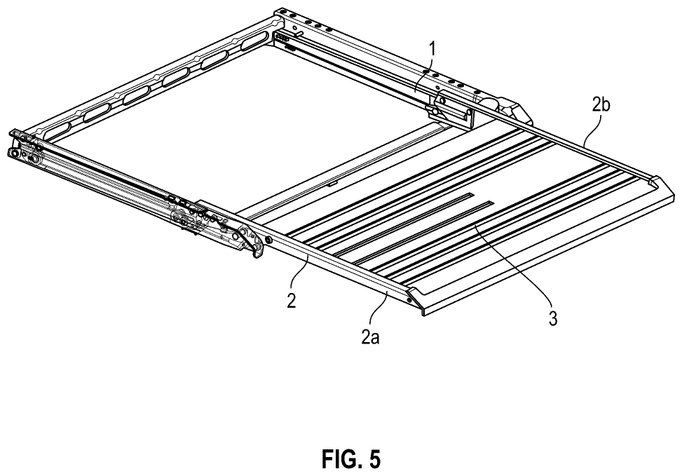

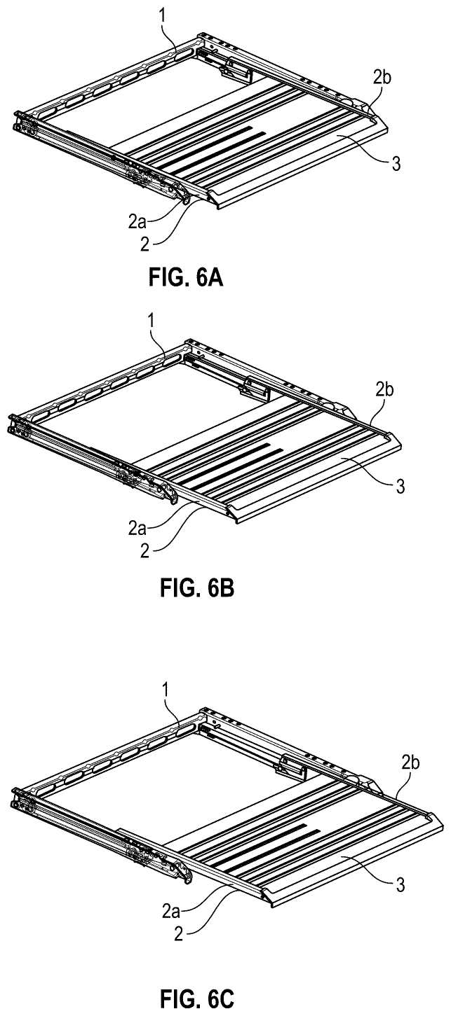

FIGS. 1A and 5 illustrate the rails (2a) and (2b) of the sliding mechanism (2) and the first floor (3) connected thereto in the stowed position and the extended position, respectively. In transitioning the first floor (3) from an unlocked state to a locked state, each of the catches (9) rotates upon contact with the striker pin (8) mounted on the rear portion or the front portion of the frame (1) on a same side as the respective catch (9) until fully engaging with the striker pin (8) to lock the first floor (3) in the stowed position or the extended position, respectively. In transitioning the first floor (3) from the locked state to the unlocked state, the release handle (4) triggers the locking mechanism via the connected cables (12) to actuate rotation of each catch (9) from the striker pin (8) to which each respective catch (9) is engaged until fully disengaging from the striker pin (8) to unlock the first floor (3) from the stowed position or the extended position. Each torsion spring (10) returns the respective catch (9) to which it is connected to an unrotated position as energy stored in each torsion spring is released, causing rotation of the respective catch (9) during locking or unlocking of the first floor (3). The locking mechanism may also lock the first floor (3) in other positions between the stowed position (see FIG. 1A) and the extended position (see FIG. 5). For example, FIGS. 6A-6C illustrate the rails (2a) and (2b) of the sliding mechanism (2) and the first floor (3) connected thereto extended respectively to 25%, 50%, and 75% of a maximum extension shown in FIG. 5.

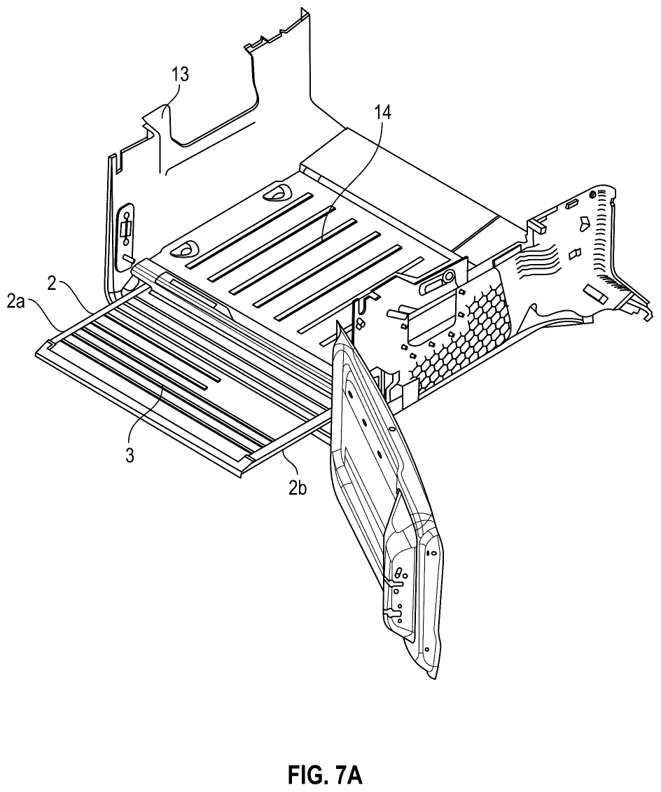

FIGS. 7A and 7B illustrate the extendable load bearing floor integrated into a vehicle (13) such that the first floor (3) is essentially unseen when in the stowed position (FIG. 7B). A second floor (14) positioned above the first floor (3) is a floor of a cargo bed of the vehicle (13). The first floor (3) is stowed beneath the second floor (14) when in the stowed position and slides out from beneath the second floor (14) when transitioning from the stowed position to the extended position. To extend the first floor (3) from the stowed position, the release handle (4) is engaged to trigger the locking mechanism, unlocking the locking mechanism such that the sliding mechanism (2) and first floor (3) connected thereto may slide away from the vehicle (13) in a longitudinal direction in relation to the frame (1) until the locking mechanism is engaged, locking the sliding mechanism (2) and first floor (3) connected thereto in the extended position. To stow the first floor (3) from the extended position, the release handle (4) is engaged to trigger the locking mechanism, unlocking the locking mechanism such that the sliding mechanism (2) and first floor (3) connected thereto may slide towards the vehicle (13) in the longitudinal direction in relation to the frame (1) until the locking mechanism is engaged, locking the sliding mechanism (2) and first floor (3) connected thereto in the stowed position.

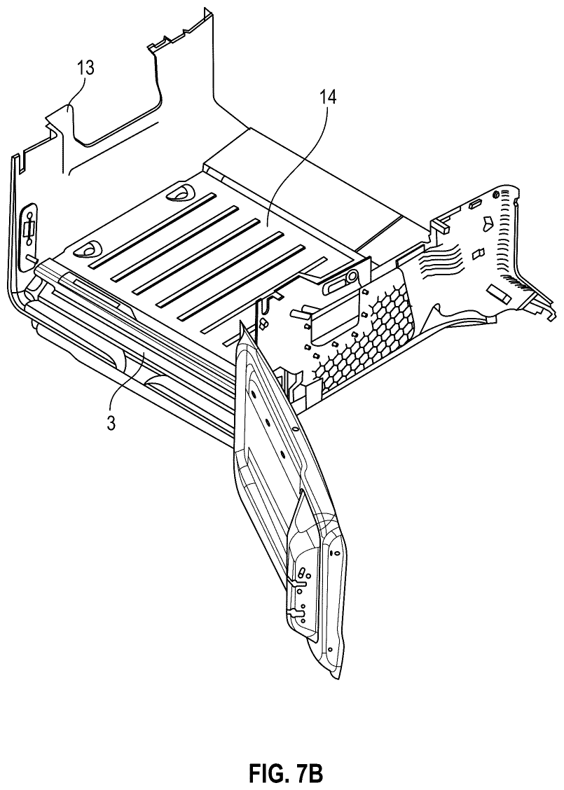

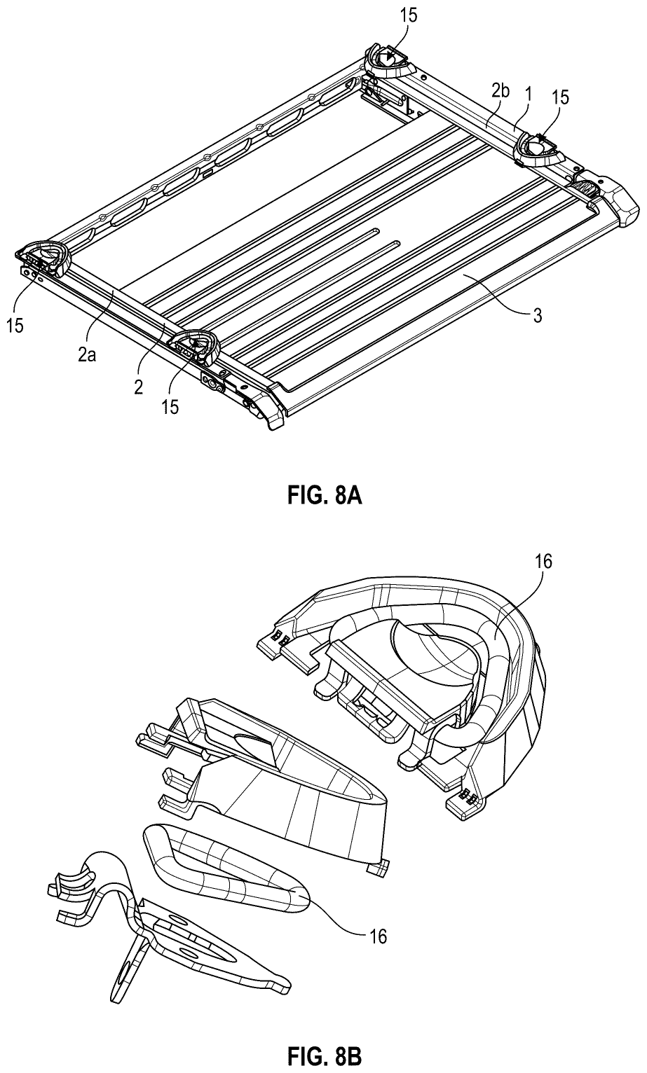

FIG. 8A illustrates the extendable load bearing floor with hooks (15) mounted to the frame (1) on opposite sides. FIG. 8B illustrates exploded and assembled views of the hooks (15) including a tie down eye (16) adapted to pivot up to 90 degrees and stow flush for storage.

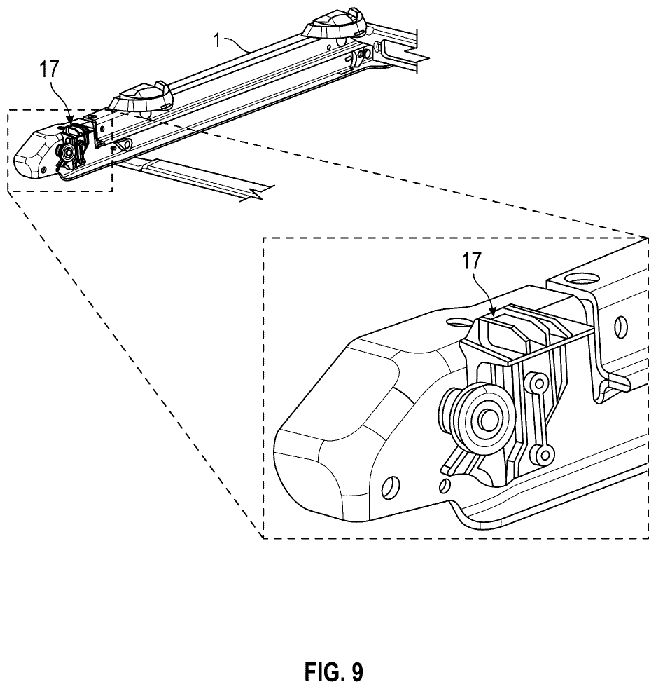

FIG. 9 illustrates the extendable load bearing floor with vertically limiting stops (17) mounted to opposite sides of one of the frame (1) to prevent the first floor (3) from moving in a vertical direction in relation to the frame (1).

The particular arrangement of at least some of the elements described herein may be modified as will be apparent to those skilled in the art. Although embodiments of the invention have been illustrated, it will be apparent to the skilled workmen that variations or modifications of the illustrated structure may be made without departing from the spirit or scope of the invention.

1. An extendable load bearing floor for a vehicle, comprising:
a frame;
a sliding mechanism slidingly coupled with the frame in a longitudinal direction;
a first floor connected to the sliding mechanism; and
a release handle adapted to trigger a locking mechanism;
wherein:
the locking mechanism locks the sliding mechanism and the first floor connected thereto in at least a stowed position and an extended position;
the locking mechanism is triggered to unlock the sliding mechanism and the first floor connected thereto from either of the stowed position and the extended position to freely translate longitudinally in relation to the frame between the stowed position and the extended position and vice versa;
the locking mechanism comprises at least one catch mounted to the sliding mechanism, the at least one catch being configured to rotate out of engagement with at least one striker pin coupled to the frame in response to the triggering of the locking mechanism to unlock the sliding mechanism and the first floor connected thereto;
the at least one catch rotates upon contact with the striker pin until fully engaged with the at least one striker pin to lock the sliding mechanism and the first floor connected thereto;
and
the extendable load bearing floor is integrated into the vehicle.

2. The extendable load bearing floor of claim 1, further comprising a second floor positioned above the first floor such that the first floor is stowed beneath the second floor when in the stowed position and slides out from beneath the second floor when transitioning from the stowed position to the extended position.

3. The extendable load bearing floor of claim 2, wherein the second floor is a floor of a bed of the vehicle.

4. The extendable load bearing floor of claim 1, wherein the sliding mechanism comprises:
a pair of rails slidingly coupled with opposite sides of the frame in the longitudinal direction;
wherein:
the outer surface of each rail faces the inner surface of the respective side of the frame to which each rail is slidingly coupled in the longitudinal direction;
the first floor is connected to each rail and positioned between an inner surface of each rail; and
guide rollers and load rollers facilitate longitudinal translation of each rail in relation to the frame, wherein:
one guide roller is mounted to at least each of an inner surface of a front portion of each side of the frame and an outer surface of a rear portion of each rail; and
one load roller is mounted to at least each of the inner surface of the front portion of each side of the frame and the outer surface of the rear portion of each rail.

5. The extendable load bearing floor of claim 4, wherein:
a bumper is mounted to at least each of the inner surface of a rear portion and the front portion of each side of the frame; and
the bumpers mounted on the rear portion and the front portion of the frame are adapted to engage with the load roller mounted on the outer surface of each rail on a same side as the respective bumper to provide over travel and noise protection in the stowed position and the extended position, respectively.

6. The extendable load bearing floor of claim 1, wherein:
the at least one striker pin comprises one striker pin mounted to at least each of a rear portion and a front portion of an inner surface of each side of the frame;
the at least one catch comprises one catch mounted to at least each of a rear portion of an outer surface of each side of the sliding mechanism; and
one torsion spring connected to each catch;
wherein:
each catch is connected to the release handle via a cable;
in transitioning the first floor from an unlocked state to a locked state, each of the catches rotate upon contact with the striker pin mounted on the rear portion or the front portion of the frame on a same side as the respective catch until fully engaging with the striker pin to lock the first floor in the stowed position or the extended position, respectively;
in transitioning the first floor from the locked state to the unlocked state, the release handle triggers the locking mechanism via the connected cables to actuate rotation of each catch from the striker pin to which each respective catch is engaged until fully disengaging from the striker pin to unlock the first floor from the stowed position or the extended position;
and
each torsion spring returns the respective catch to which it is connected to an unrotated position after a force causing rotation of the respective catch during locking or unlocking of the first floor is released.

7. The extendable load bearing floor of claim 6, wherein the locking mechanism further comprises one catch bumper mounted to at least each of the rear portion of the outer surface of each side of the sliding mechanism to limit an amount of rotation of the catch mounted on a same side.

8. The extendable load bearing floor of claim 6, wherein the sliding mechanism comprises:
a pair of rails slidingly coupled with opposite sides of the frame in the longitudinal direction;
wherein:
the outer surface of each rail faces the inner surface of the respective side of the frame to which each rail is slidingly coupled in the longitudinal direction;
the first floor is connected to each rail and positioned between an inner surface of each rail;
guide rollers and load rollers facilitate longitudinal translation of each rail in relation to the frame, wherein:
one guide roller is mounted to at least each of an inner surface of a front portion of each side of the frame and an outer surface of a rear portion of each rail; and
one load roller is mounted to at least each of the inner surface of the front portion of each side of the frame and the outer surface of the rear portion of each rail; and
the rear portion of the outer surface of each side of the sliding mechanism comprises the outer surface of the rear portion of each rail.

9. The extendable load bearing floor of claim 1, further comprising at least two hooks mounted to the frame on opposite sides.

10. The extendable load bearing floor of claim 9, wherein each of the at least two hooks comprises a tie down eye adapted to pivot up to 90 degrees and stow flush for storage.

11. The extendable load bearing floor of claim 1, wherein the release handle is mounted to an underside of the first floor.

12. The extendable load bearing floor of claim 1, further comprising at least two vertically limiting stops mounted to opposite sides of one of the frame and the sliding mechanism to prevent the first floor from moving in a vertical direction in relation to the frame.

13. The extendable load bearing floor of claim 1312, wherein the at least two vertically limiting stops are fabricated using injection molding.

14. The extendable load bearing floor of claim 1, wherein the locking mechanism locks the sliding mechanism and the first floor connected thereto in at least one additional position between the stowed position and the extended position.
